(19) United States
(12) Patent Application Publication
(10) Pub. No.: US 2017/0131454 A1
(43) Pub. Date: May 11, 2017

(54) BACKLIGHT MODULE AND LIQUID CRYSTAL DISPLAY DEVICE COMPRISING THE SAME

(71) Applicants: Shenzhen China Star Optoelectronics Technology Co. Ltd., Shenzhen, Guangdong (CN); Wuhan China Star Optoelectronics Technology Co., Ltd., Wuhan, Hubei (CN)

(72) Inventor: Yanxue Zhang, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/778,122

(22) PCT Filed: Feb. 27, 2015
(86) PCT No.: PCT/CN2015/073374

§ 371 Date: Nov. 21, 2016

(30) Foreign Application Priority Data
Feb. 11, 2015 (CN) 201510072490.0

(51) Int. Cl. F21V 8/00; G02F 1/1333

(52) U.S. Cl. CPC G02B 6/0036; G02B 6/0055; G02B 6/0051; G02B 6/0088; G02F 1/133308

(57) ABSTRACT

Disclosed is a backlight module and a liquid crystal display device comprising the backlight module. The backlight module includes a light source, and a light guide plate assembly, which has a light guide plate substrate provided with a mounting slot, wherein the light source is fixed into the mounting slot. According to the backlight module, the light source is arranged on the light guide plate substrate through integration, which enables the backlight module to have a compact structure and therefore to be convenient to assemble.

### CROSS-REFERENCE TO RELATED APPLICATIONS

The present application claims benefit of Chinese patent application CN 201510072490.0, entitled “Backlight module and liquid crystal display device comprising the same” and filed on Feb. 11, 2015, the entirety of which is incorporated herein by reference.

### FIELD OF THE INVENTION

The present disclosure relates to the technical field of liquid crystal display, and in particular, to a backlight module and a liquid crystal display device comprising the backlight module.

### BACKGROUND OF THE INVENTION

A liquid crystal display device comprises a backlight module, and a liquid crystal display panel, which, as a passive light-emitting element, does not emit light itself, but is illuminated by the backlight module arranged therebeneath. Thus, the substantial function of the backlight module, as one of the essential components of the liquid crystal display device, is to provide sufficient brightness and homogeneously distributed light sources to the liquid crystal display device. As a result, the liquid crystal display device can normally display images.

As shown in FIG. 1, a backlight module 90 in the prior art typically includes a peripheral frame 91, a rubber frame 92, a reflective sheet 93, a light guide plate 94, a prism sheet 95, a diffusion sheet 96, and a light source 97. However, such a backlight module 90 is structurally complex, which is unfavorable for assembling thereof and moreover is of high manufacturing costs.

### SUMMARY OF THE INVENTION

Directed against the above technical problems in the art, the present disclosure provides a backlight module and a liquid crystal display device comprising the backlight module. The backlight module is simple in structure, which facilitates manufacture thereof. Meanwhile, the material costs of the backlight module are low, thereby lowering manufacturing costs thereof. In addition, the backlight module is convenient to assemble during manufacture, thus improving manufacturing efficiency of a liquid crystal display device.

According to a first aspect of the present disclosure, a backlight module is provided, comprising:
a light source, and
a light guide plate assembly, which has a light guide plate substrate provided with a mounting slot,
wherein the light source is fixed into the mounting slot.

In one embodiment, the mounting slot is configured as a through slot located on the light guide plate substrate, or as a plurality of spaced slots located on the light guide plate substrate.

In one embodiment, an upper portion of the light guide plate substrate is provided with a prism layer, which comprises a plurality of projections regularly distributed on a prism layer base arranged in parallel with a lower surface of the light guide plate substrate.

In one embodiment, the projections are configured in shape of prisms arranged in parallel with one another, the projections each having gradually reduced cross-section areas in a direction from bottom to top.

In one embodiment, in a direction from bottom to top of the light guide plate substrate, two prism layers are provided, and the projections of one of the two prism layers are distributed in a direction, which forms a certain angle with respect to a direction along which the projections of the other of the two prism layers are distributed.

In one embodiment, the angle is a right angle, and/or the projections have triangular, polygonal, or curved cross-sections.

In one embodiment, the prism layer is formed through a three-dimensional printing technology.

In one embodiment, a reflective layer is arranged on the lower surface of the light guide plate substrate, and/or a particle diffusion layer is arranged on an upper surface of the light guide plate substrate.

In one embodiment, a retaining frame used for defining a liquid crystal display panel is arranged on an upper surface of the particle diffusion layer.

According to a second aspect of the present disclosure, a liquid crystal display device is provided, comprising the above backlight module.

In the present disclosure, spatial reference “lower” indicates the side of the backlight module of the liquid crystal display device, and the spatial reference “upper,” which is opposite to the spatial reference “lower,” indicates the side of the liquid crystal display panel of the liquid crystal display device.

Compared with the prior art, the advantages of the present disclosure are as follows. According to the backlight module of the present disclosure, the light source is arranged on the light guide plate substrate through integration, which enables the backlight module to have a compact structure and therefore to be assembled conveniently. Besides, the prism layer is arranged on the light guide plate substrate, so that the light guide plate assembly is further integrated, thereby simplifying the structure and facilitating assembling thereof. Meanwhile, the prism layer structure in such an arrangement does not allow much light loss, and is therefore efficient. In addition, the reflective sheet, the particle diffusion layer, and the like are arranged on the light guide plate substrate, which allows the light guide plate assembly to be further integrated, thereby optimizing material costs in manufacture, and simplifying assembling procedures.

### BRIEF DESCRIPTION OF THE DRAWINGS

In the following, preferred embodiments of the present disclosure will be explained in detail in connection with the accompanying drawings, in which:

FIG. 1 shows a structural diagram of a backlight module in the prior art;

FIG. 2 shows a structural diagram of a backlight module according to the present disclosure;

FIG. 3 shows a perspective view of a light guide plate assembly according to the present disclosure; and

FIG. 4 shows a perspective view of a liquid crystal display device according to the present disclosure.

In the drawings, the same components are indicated with the same reference signs. The figures are not drawn in accordance with an actual scale.

### DETAILED DESCRIPTION OF THE EMBODIMENTS

The present disclosure will be further explained with reference to the accompanying drawings.

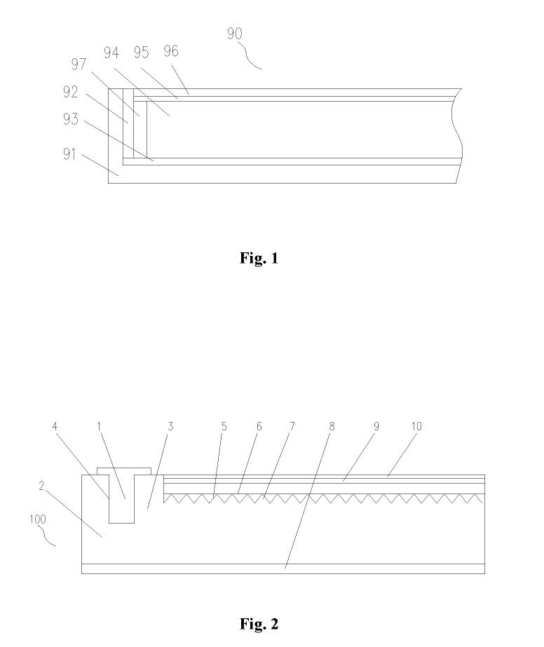

FIG. 2 shows a backlight module 100 according to the present disclosure. As depicted in FIG. 2, the backlight module 100 comprises a light source 1 and a light guide plate assembly 2. The light guide plate assembly 2 has a light guide plate substrate 3, a side of which is provided with a mounting slot 4 for accommodating the light source 1.

As such, the light source 1 can be integrated onto the light guide plate substrate 3, which can thereby guide transmission direction of light emitted by the light source 1, and transfer a point light source or a linear light source into a surface light source. Moreover, such a structure can facilitate positioning of the light source 1, thereby simplifying subsequent assembling procedures.

The mounting slot 4 can be configured as a through slot or spaced slots as per whether the light source 1 is a linear or point light source. However, in order to simplify the structure of the light guide plate substrate 3 per se, the mounting slot 4 can be configured into a through slot regardless of what type the light source is. In addition, the light guide plate substrate 3 can be provided with the light source 1 on two or more sides thereof, depending on the size thereof or on actual requirements on luminous efficiency, so as to achieve better light effects. Besides, the mounting slot 4 can also be arranged on a lower surface of the light guide plate substrate 3, which can thus be used in a backlight type backlight module.

The light guide plate substrate 3 can be made of an acrylic material, so as to enable the light guide plate assembly 2 to have strong light penetration.

According to the present disclosure, a prism layer 5 can be provided between an upper surface and the lower surface of the light guide plate substrate 3. In particular, the prism layer 5 can be arranged on an upper portion, between the upper and lower surfaces of the light guide plate substrate 3, i.e., a portion adjacent to the upper surface of the light guide plate substrate 3. The prism layer 5 comprises projections 7 regularly distributed on a prism layer base 6, which is in parallel with the lower surface of the light guide plate substrate 3.

The projections 7 can be configured in shape of prisms in parallel with one another. That is, the prism layer base 6 can be slotted to form the projections 7, which are strip-shaped and substantially in parallel with one another, on the prism layer base 6. In addition, the projections 7 each have gradually reduced cross-section areas in a direction from bottom to top. The prism layer 5 can be used for performing light condensation, so as to enhance brightness of light.

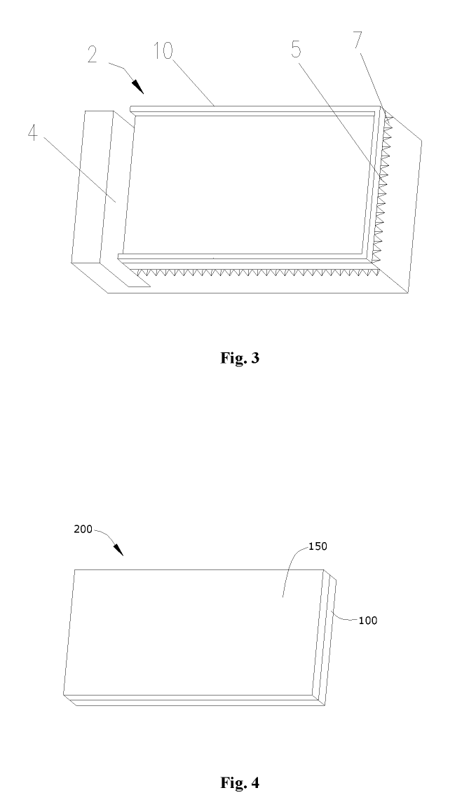

In order to improve efficiency of light condensation, and meanwhile prevent light loss, two or more prism layers 5 can be arranged in the light guide plate substrate 3 in a direction from bottom to top thereof. Preferably, two prism layers 5 are arranged, as shown in FIG. 3, wherein the prism layer base 6 of the upper prism layer 5 is placed on the projections 7 of the lower prism layer 5. Preferably, the direction of projections 7 of one of the prism layers 5 forms a certain angle with respect to the direction of projections 7 of another of the prism layers 5. More preferably, the direction of projections 7 of one of the prism layers 5 forms a right angle with respect to the direction of projections 7 of another of the prism layers 5. That is, the projections 7 of the upper prism layer 5 and the projections 7 of the lower prism layer 5 extend in two directions perpendicular to each other. Such being the case, the optical efficiency of the light guide plate assembly 2 can be further improved.

As illustrated in the figure, the cross section of the projection 7 can be a triangle in shape. The present disclosure, however, is not limited hereto. That is, the cross section of the projection 7 can be in other structural forms, such as polygons and curved surfaces.

It should be noted that, the projections 7 are not limited to the above structures or distributions on the prism layer base 6, as long as they are homogeneously distributed, allow light to exit from the prism layer 5 in a concentrated manner, and can therefore improve brightness of light.

According to the present disclosure, the structure of the prism layer 5 on the light guide plate assembly 2 can be formed through a 3D printing technology. That is, the 3D printing technology can be used to form a hollow structure of a plurality of prism layers 5.

In one embodiment, a reflective sheet 8 can be provided on the lower surface of the light guide plate substrate 3, and used for reflecting light leaked out of the light guide plate substrate 3 back into the light guide plate substrate 3. Preferably, the reflective sheet 8 can be a thin metal (aluminum, silver, or the like) film coated on the lower surface of the light guide plate substrate 3.

The upper surface of the light guide plate substrate 3 can be provided with a particle diffusion layer 9 thereon, which comprises a high-molecular compound and several diffusion particles. The high-molecular compound can be adhered on the upper surface of the light guide plate substrate 3 by, for example, being sprayed, roller coated, or screen printed. As a result, phenomena such as intensive refraction, reflection, and scattering will occur when light passes through the particle diffusion layer 9, thereby causing an effect of optical diffusion.

An upper surface of the particle diffusion layer 9 can be further provided with a retaining frame 10, which is formed by strip bodies circumferentially protruding from the upper surface of the particle diffusion layer 9, and distributed on a side of the light guide plate assembly 2 where no light source is arranged. The retaining frame 10 is used for, in a mounting state, defining a position of a liquid crystal display panel.

It should be noted that the backlight module 100 further comprises other structures, such as a peripheral frame. Such structures are well known to those skilled in the art, and will therefore not be explained in detail herein.

According to the present disclosure, it further provides a liquid crystal display device 200. As shown in FIG. 4, the liquid crystal display device 200 comprises a liquid crystal display panel 150 and a backlight module 100. The liquid crystal display device 200 can be any products or components having a display function, such as a liquid crystal display television, a liquid crystal display, a digital photo frame, a mobile phone, and a tablet computer.

According to the present disclosure, the functions of a light guide plate, a reflective sheet, a diffusion sheet, and the like in the prior art are effectively integrated into the light guide plate assembly 2 of the backlight module 100. Hence, the functions of a conventional backlight module are maintained in a simplified structure. Particularly, such a simplified structure of the backlight module brings down the costs of material, and meanwhile renders the backlight module lighter and thinner. In addition, the backlight module 100 of such a structure is easy to assemble, thereby simplifying assembling procedures and saving operating time.

The above description should not be construed as limitations of the present disclosure, but merely as exemplifications of preferred embodiments thereof. Any variations or replacements that can be readily envisioned by those skilled in the art are intended to be within the scope of the present disclosure. Hence, the scope of the present disclosure should be subject to the scope defined in the claims.

1. A backlight module, comprising:
a light source, and
a light guide plate assembly, which has a light guide plate substrate provided with a mounting slot,
wherein the light source is fixed into the mounting slot.

2. The backlight module according to claim 1, wherein the mounting slot is configured as a through slot located on the light guide plate substrate, or
wherein the mounting slot is configured as a plurality of spaced slots located on the light guide plate substrate.

3. The backlight module according to claim 1, wherein an upper portion of the light guide plate substrate is provided with a prism layer, which comprises a plurality of projections regularly distributed on a prism layer base arranged in parallel with a lower surface of the light guide plate substrate.

4. The backlight module according to claim 3, wherein the projections are configured in shape of prisms arranged in parallel with one another, the projections each having gradually reduced cross-section areas in a direction from bottom to top.

5. The backlight module according to claim 4, wherein in a direction from bottom to top of the light guide plate substrate, two prism layers are provided, and the projections of one of the two prism layers are distributed in a direction, which forms a certain angle with respect to a direction along which the projections of the other of the two prism layers are distributed.

6. The backlight module according to claim 5, wherein the angle is a right angle, and/or
wherein the projections have triangular, polygonal, or curved cross-sections.

7. The backlight module according to claim 3, wherein the prism layer is formed through a three-dimensional printing technology.

8. The backlight module according to claim 1, wherein a reflective layer is arranged on the lower surface of the light guide plate substrate, and/or
wherein a particle diffusion layer is arranged on an upper surface of the light guide plate substrate.

9. The backlight module according to claim 8, wherein a retaining frame used for defining a liquid crystal display panel is arranged on an upper surface of the particle diffusion layer.

10. A liquid crystal display device comprising a backlight module, which includes:
a light source, and
a light guide plate assembly, which has a light guide plate substrate provided with a mounting slot,
wherein the light source is fixed into the mounting slot.

11. The liquid crystal display device according to claim 10, wherein the mounting slot is configured as a through slot located on the light guide plate substrate, or
wherein the mounting slot is configured as a plurality of spaced slots located on the light guide plate substrate.

12. The liquid crystal display device according to claim 10, wherein an upper portion of the light guide plate substrate is provided with a prism layer, which comprises a plurality of projections regularly distributed on a prism layer base arranged in parallel with a lower surface of the light guide plate substrate.

13. The liquid crystal display device according to claim 12, wherein the projections are configured in shape of prisms arranged in parallel with one another, the projections each having gradually reduced cross-section areas in a direction from bottom to top.

14. The liquid crystal display device according to claim 13, wherein in a direction from bottom to top of the light guide plate substrate, two prism layers are provided, and the projections of one of the two prism layers are distributed in a direction, which forms a certain angle with respect to a direction along which the projections of the other of the two prism layers are distributed.

15. The liquid crystal display device according to claim 14, wherein the angle is a right angle, and/or wherein the projections have triangular, polygonal, or curved cross-sections.

16. The liquid crystal display device according to claim 12, wherein the prism layer is formed through a three-dimensional printing technology.

17. The liquid crystal display device according to claim 10, wherein a reflective layer is arranged on the lower surface of the light guide plate substrate, and/or wherein a particle diffusion layer is arranged on an upper surface of the light guide plate substrate.

18. The liquid crystal display device according to claim 17, wherein a retaining frame used for defining a liquid crystal display panel is arranged on an upper surface of the particle diffusion layer.
